(19) United States
(12) Patent Application Publication
(10) Pub. No.: US 2025/0363429 A1
(43) Pub. Date: Nov. 27, 2025

(54) LOCATION QUEUING USING DIGITAL INSTRUMENTS

(71) Applicant: AMERICAN EXPRESS TRAVEL RELATED SERVICES COMPANY, INC., New York, NY (US)

(72) Inventors: Alexandra LEE, Madison, CT (US); Jonathan BRODHEIM, San Francisco, CA (US); Shridevi BAICHWAL, Bella Vista (AU); Adam Craig WILKINSON, Horsham (GB); Samantha Lee SALESE, Brooklyn, NY (US); Michael Grey BRYANT, Brooklyn, NY (US); Rebecca Anne WIENKE, Santa Monica, CA (US)

(73) Assignee: AMERICAN EXPRESS TRAVEL RELATED SERVICES COMPANY, INC., New York, NY (US)

(21) Appl. No.: 18/674,371

(22) Filed: May 24, 2024

(51) Int. Cl. G06Q 10/047; G06F 3/0482

(52) U.S. Cl. CPC G06Q 10/047; G06F 3/0482

(57) ABSTRACT

When a queue time satisfies a queuing threshold for a facility (e.g., a lounge, a venue, merchant location, any defined area, etc.), a notification of the queue time may be sent to a user device. A user interface of the user device may be used to provide credential information, and based on the credential information, display an indication of a digital instrument. A selection of the digital instrument may cause the user device to display a requirement for accessing the facility. Based on a confirmation of the requirement for accessing the facility and an indication that the queue time is less than the queuing threshold, the user device may display image data (e.g., a barcode, a matrix barcode, a quick response (QR) code, Radio Frequency Identification (RFID) tag, a marker, etc.) encoded with an access identifier that enables access to the facility.

### BRIEF SUMMARY

In a digital queuing system (e.g., a physical queuing system, an electronic queue, a wait and/or service line, etc.), when a queue time satisfies a queuing threshold for a facility (e.g., a lounge, a venue, merchant location, any defined area, etc.), a notification of the queue time may be sent to a user device. The improvement relates to the coordination of functionality between a digital queuing system and a digital instrument system, two systems that typically do not communicate with each other. A user interface of the user device may be used to provide credential information (e.g., a user/user device identifier, a password, a biometric, etc.). Based on the credential information, the user interface may display an indication of a digital instrument (e.g., a digital wallet account, a virtual card, a payment card, etc.). According to some aspects of this disclosure, the credential information may be associated with multiple digital instruments that are displayed by the user interface. A selection of a digital instrument may cause the user device to display a requirement for accessing the facility. According to some aspects of this disclosure, requirements for accessing the facility may change and/or be different based on which digital instrument is selected. Based on a confirmation of the requirement for accessing the facility and an indication that the queue time is less than the queuing threshold, the user device may display image data (e.g., a barcode, a matrix barcode, a quick response (QR) code, Radio Frequency Identification (RFID) tag, a marker, etc.) encoded with an access identifier that enables access to the facility.

### BRIEF DESCRIPTION OF THE DRAWINGS

The accompanying drawings are incorporated herein and form a part of the specification.

FIG. 1 shows a block diagram of a system for location queuing using digital instruments, according to some aspects of this disclosure.

FIGS. 2A-2D show an example user interface for location queuing using digital instruments, according to some aspects of this disclosure.

FIG. 3 shows a flowchart of an example method for location queuing using digital instruments, according to some aspects of this disclosure.

FIG. 4 shows an example computer system useful for implementing various aspects of this disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for location queuing using digital instruments. Current queuing systems struggle with efficient queue management, such as management of occupancy in public and private spaces, particularly in environments where safety and user experience are paramount, because these systems typically rely exclusively on manual interaction. For example, a user may have to present his name or identification to a customer service agent managing the queue. The customer service agent may then enter the user's information into the queuing system. Manual action within current queuing systems can lead to excessive wait times and/or long queues for users and/or user devices to access facilities (e.g., a lounge, a venue, merchant location, etc.), utilize services, and/or the like as populations increase and demand to access facilities, utilize services, and/or the like increase accordingly. The problem with current queuing systems and their failure to communicate with other digital system, which leads to excessive wait times and long queues, presents a significant technical challenge and detracts from user satisfaction. With regard to facility access, such delays are primarily caused by traditional access and/or entry procedures that rely on manual check-ins, physical verification of eligibility through paperwork or digital devices, and a lack of real-time data processing capabilities. For example, conventional methods of managing entry to a facility such as an airport lounge and/or the like are inefficient, time-consuming, and often unable to cope with high volumes of uses and/or user devices, especially during peak travel times and other high volume periods. Furthermore, the physical space designated for queues (e.g., wait lines, etc.) often becomes overcrowded, leading to discomfort and a stressful environment.

Conventional queue management and occupancy systems often fail to provide real-time capacity and occupancy data, lack digital interaction capabilities, and are not scalable to different environments or user volumes. With conventional queue management and occupancy systems, users/user devices are unable to enter a queue and/or join a waitlist for access to a facility since the users/user devices are routinely unaware that the waitlist is active without physically visiting the facility. When physically visiting a facility, users/user devices are routinely required to wait in a physical line and/or manually engage support personnel. Conventional queue management and occupancy systems struggle to efficiently manage varying flow rates of user and user devices, which can fluctuate dramatically. Inefficiencies in queue management and facility entry processes can also pose security risks, as hurried user and user device evaluations may lead to oversight and reduced effectiveness of security protocols.

According to some aspects of this disclosure, a system, apparatus, device, method and/or computer program product embodiments, and/or combinations and sub-combinations thereof, for location queuing using digital instruments may leverage location observation data, sensor data, digital instrument data, and/or the like for real-time monitoring of capacity and occupancy levels in a facility (e.g., a lounge, a venue, merchant location, any defined area, etc.) and managing queuing between users within the digital queuing system. In a crowded area including, but not limited to, an airport lounge and/or the like, location queuing using digital instruments, as described herein, facilitates optimal occupancy at least in part via automated notifications and a digital/virtual waitlist management for potential entrants in proximity to the area. The improvements of the queuing system in coordination with digital instrument systems facilitate user interfaces for viewing the current occupancy status of a facility, joining a digital/virtual waitlist, and transmitting and receiving notifications as space becomes available, thus optimizing user flow and space utilization.

As described herein, at least the technical fields of capacity management, logistic management and/or the like are improved by the system, apparatus, device, method and/or computer program product embodiments, and/or combinations and sub-combinations thereof, for location queuing using digital instruments which streamline the entry process into facilities, enhance the user experience by significantly reducing wait times for certain users, and improve the overall efficiency and security of facility entry operations. As further described herein, features relate to an improvement in the functioning of digital queuing systems by combining the use of location queuing using digital instruments with digital instrument systems to manage digital queuing and management of the digital queue.

According to some aspects of this disclosure, location queuing using digital instruments may be implemented via a digital queuing application configured with a user device and/or the like. The digital waitlist application enhances the functioning of a computer, particularly in environments including, but not limited to, airports, service centers, healthcare facilities, restaurants, and/or any queue-based setting, by organizing and managing the demand for computational resources or services efficiently. By managing the use of CPU, memory, and storage utilities invoked to facilitate access to a location, computational resources are allocated effectively based on priority and necessity. For example, computational resources used to identify a queue/wait time for a user device to access a facility may be reduced by identifying a digital instrument associated with the user device that enables expedited access to the facility. The digital queuing application ensures that computing systems managing access to locations/facilities do not become overloaded and reduces the risk of system freezing, crashing, and/or the like—thereby improving reliability. The digital queuing application may provide valuable data on facility usage patterns, peak operating times, and typical queue/wait times. This data can be used to further refine resource allocation strategies and system configurations for continuous improvements in system performance. These and other technological advantages are described herein.

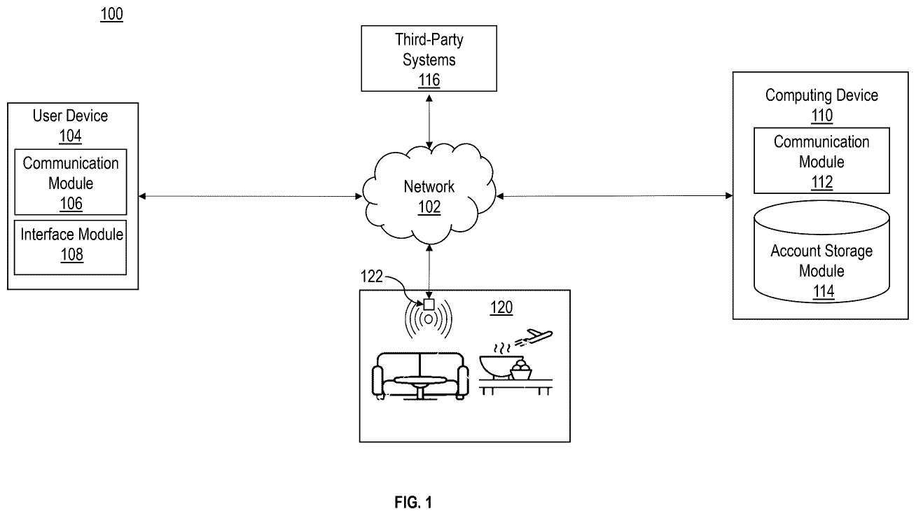

FIG. 1 shows an example system 100 for location queuing using digital instruments. System 100 is merely an example of one suitable environment and is not intended to suggest any limitation as to the scope of use or functionality of aspects described herein. System 100 should not be interpreted as having any dependency or requirement related to any single device/module/component or combination of devices/modules/components described therein.

System 100 may include a network 102. According to some aspects of this disclosure, system 100 may include a network 102. Network 102 may include a packet-switched network (e.g., internet protocol-based network), a non-packet-switched network (e.g., quadrature amplitude modulation-based network), and/or the like. Network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. Network 102 may include a payment network and/or may support/facilitate financial transactions. Network 102 may provide and/or support communication from a telephone, cellular phone, modem, and/or other electronic devices to and throughout the system 100. For example, system 100 may include and support communications between a user device 104, a computing device 110, and a third-party system 116 via network 102.

User device 104 may include a smart device, a mobile device, a computing device, and/or any other device capable of communicating with network 102 and/or device/components in communication with network 102. Although only a single user device 104 is shown, according to some aspects of this disclosure, system 100 may include any number of user devices 104.

User device 104 may include a communication module 106 that facilitates and/or enables communication with network 102 (e.g., devices, components, and/or systems of network 102, etc.), computing device 110, third-party system 116, and/or any other device/component of the system 100. For example, communication module 106 may include hardware and/or software to facilitate communication. Communication module 106 may comprise one or more of a modem, transceiver (e.g., wireless transceiver, etc.), digital-to-analog converter, analog-to-digital converter, encoder, decoder, modulator, demodulator, tuner (e.g., Quadrature Amplitude Modulation (QAM) tuner, Quadrature Phase Shift Keying (QPSK) tuner), and/or the like. Communication module 106 may include any hardware and/or software necessary to facilitate communication.

According to some aspects of this disclosure, user device 104 may include an interface module 108. Interface module 108 enables a user to interact with user device 104, network 102, computing device 110, third-party system 116, and/or any other device/component of system 100. Interface module 108 may include any interface for presenting and/or receiving information to/from a user. According to some aspects of this disclosure, interface module 108 may include a web browser, a mobile device application (e.g., a digital queuing/waitlist application, a payment application, etc.), and the like. Other software, hardware, and/or interfaces can be used to provide communication between user device 104, network 102, computing device 110, third-party system 116, and/or any other device/component of system 100. Interface module 108 may request/query and/or send/provide various files from a local source and/or a remote source, such as computing device 110, third-party system 116, and/or any other device/component of system 100.

According to some aspects of this disclosure, interface module 108 may include one or more input devices and/or components, for example, such as a keyboard, a pointing device (e.g., a computer mouse, remote control), a microphone, a joystick, a tactile input device (e.g., touch screen, gloves, etc.), and/or the like. According to some aspects of this disclosure, interaction with the input devices and/or components may enable a user to view, access, interact, request, and/or navigate a user interface generated, accessible, and/or displayed by interface module 108. According to some aspects of this disclosure, interaction with the input devices and/or components may enable a user to manipulate and/or interact with components of a user interface. For example, interaction with the input devices and/or components of interface module 108 enables a user to log in and/or navigate to a digital waitlist associated with a facility, such as facility 120.

User device 104 may include and/or be associated with a digital wallet. The digital wallet may include payment information and passwords associated with user device 104 (e.g., associated with a user of user device 104). For example, the digital wallet may include information related to a digital instrument such as a payment card and/or the like. A payment card may be associated with a primary account number (PAN). In some instances, the PAN may be tokenized for security. The PAN associated with user device 104 may be stored by a payment network (e.g., a payment network configured with, supported by, and/or enabled by network 102, etc.) in a database record linked to a payment account (and/or user profile) associated with a user (e.g., a user associated with and/or using user device 104, etc.). For example, a user device 104 (or user of user device 104) may be associated with a unique identifier that is linked to a digital wallet. The digital wallet may be linked and/or associated with different digital instruments, payment utilities, and/or methods, for example, a payment account.

User device 104 may also include and/or be associated with a digital queuing application that may be implemented locally as an application on user device 104 and/or as a website. User device 104 may be configured to enable interaction between the digital wallet and the digital queuing application, such as sharing conditions or parameters associated with the digital wallet (e.g., provided by the user device 104 or from third party systems 116) with the digital queuing application.

A payment account represented by a digital instrument and linked to a digital wallet may be maintained/controlled by a third-party system 116. For example, third-party system 116 may include and/or be part of a device/network associated with a financial institution that issues the payment account. According to some aspects of this disclosure, although not shown, system 100 may include multiple third-party systems 116. According to some aspects of this disclosure, the digital wallet may be associated with multiple digital instruments that are each supported by one or more third-party systems 116. Each digital instrument may also be associated with different parameters that may be shared with a digital queuing application. The digital queuing application may then use the different parameters to condition access to a digital queue.

According to some aspects of this disclosure, a digital instrument, such as a payment card and/or the like, may be associated with various services, rewards, and/or programs supported by third-party systems and available to a user and/or user device 104. For example, a digital instrument may be associated with conditions, a service, reward, and/or program that permits or provides certain conditions for processing by the digital queuing application (e.g., for a user and/or user device 104 to access facility 120).

According to some aspects of this disclosure, facility 120 may include any location, area, building, room, and/or the like. For example, facility 120 may include an airport lounge and/or the like. Entry to facility 120 may be available to users and/or user devices associated with a digital instrument, such as a payment card and/or the like.

According to some aspect of this disclosure, facility 120 may include one or more sensors, such as sensor 122. Sensor 122 may include, but is not limited to an imaging device, a motion detection device, an infrared sensing device, a light detection and ranging (LiDAR) device, and/or the like. Sensor 122 may be positioned within facility 120 to monitor the amount of user/users devices within facility 120. Information from sensor 122 may be sent to computing device 110.

Computing device 110 may manage access to facility 120. According to some aspects of this disclosure, computing device 110 may include an entity-controlled device, a server, a cloud-based compute resource, or any other device capable of communicating with user device 104, third-party systems 116, facility 120 (e.g. sensor 122, etc.) and/or any other device/component of system 100, either described or (un)shown. Although shown as a single device, according to some aspects of this disclosure, computing device 110 may be part of a computing system and/or infrastructure, and/or may represent a plurality of computing devices. For example, computing device 110 may represent a plurality of computing devices in communication with user device 104, third-party systems 116, and/or any other device/component of system 100.

According to some aspects of this disclosure, computing device 110 may include communication module 112 that facilitates and/or enables communication with network 102 (e.g., devices, components, and/or systems of network 102, etc.), user device 104, third-party systems 116, and/or any other device/component of system 100. For example, communication module 112 may include hardware and/or software to facilitate communication. According to some aspects of this disclosure, communication module 112 may include one or more of a modem, transceiver (e.g., wireless transceiver, etc.), digital-to-analog converter, analog-to-digital converter, encoder, decoder, modulator, demodulator, tuner (e.g., QAM tuner, QPSK tuner), and/or the like. According to some aspects of this disclosure, communication module 112 may include any hardware and/or software necessary to facilitate communication.

According to some aspects of this disclosure, to manage access to facility 120, computing device 110 may include an account storage module 114. Account storage module 114 may include any physical, virtual, cloud-based, and/or network-based storage medium. Account storage module 114 may store account information for user device 104 that indicates digital instruments associated with user device 104. For example, user device 104 (e.g., users of user device 104, etc.) may have digital instruments provided by and/or registered with third-party system 116 that, based on their type, offer and/or support various rewards, value-add options, and/or user experience options. An example reward, value-add option, and/or user experience option may be an option to access facility 120.

According to some aspects of this disclosure, to access facility 120, user device 104 may provide one or more access requirements associated with a user account. Access requirements for facility 120 may be dynamic. For example, access requirements may change and/or be different for users/user devices 104 based on a type of digital instrument associated with the users/user devices 104. Facility 120 communicate with third party systems 116 and/or communication device 110 to identify the account associated with the digital instrument. In a situation where facility 120 is an airport lounge, access requirements for facility 120 may include, but are not limited to, a boarding pass, an identification element (e.g., a government issued ID, a digital identifier, a biometric, etc.), group/program membership, a qualifying airline ticket, a temporal requirement (e.g., accessing the facility within a certain timeframe, etc.), a location requirement (e.g., a lounge is at a specific departing or connecting airport, etc.), user requirements (e.g., amount of guests permitted, guest restrictions, and/or the like. This information may be shared by one or more of user device 104, third party systems 116, and/or communication device 110. For example, the information may be identified based on the digital wallet associated with user device 104, the one or more digital instruments associated with the digital wallet provided by third party system 116, and/or user information from computing device 110.

According to some aspects of this disclosure, to manage access to facility 120, computing device 110 may include a kiosk and/or terminal positioned in proximity to facility 120. According to some aspects of this disclosure, a user of computing device 110 may monitor users/user devices entering and exiting facility 120 to determine a capacity for facility 120. When a capacity level and/or queue threshold for facility 120 is reached, computing device 110 may send a notification to users/user devices within proximity to facility 120. The notification may (or may not) inform users/user devices (e.g., user device 104, etc.) that the queue threshold for facility 120 is satisfied and may indicate an option to join a waitlist.

According to some aspects of this disclosure, to manage access to facility 120, as previously described, information from sensor 122 may be sent to computing device 110. For example, sensor 122 may send computing device information indicating users/user devices within facility 120. If a threshold amount of users/user devices are detected within facility 120 (e.g. a capacity is detected, a queue threshold is reached, etc.), computing device 110 may send notification to users/user devices within proximity to facility 120. The notification may (or may not) inform users/user devices (e.g., user device 104, etc.) that a queue threshold for facility 120 is satisfied and may indicate an option to join a waitlist.

According to some aspects of this disclosure, computing device 110 may include software and/or hardware that uses communication protocols including, but not limited to HTTP (Hypertext Transfer Protocol) and/or the like to communicate information with user device 104. Computing device 124 may communicate information to user device 104 that is used to generate, render, and/or cause to display a user interface, for example, a user interface for managing access to facility 120. For example, the user interface may display information, such as a notification that a queue threshold for facility 120 is satisfied, and indicate an option to join a waitlist.

According to some aspects of this disclosure, to cause user device 104 to display a user interface for managing access to facility 120 and/or join a waitlist for access to facility 120, computing device 110 may include and/or be configured with a representational state transfer (REST) API that facilitates interactions with RESTful services, such as interactive elements (e.g., waitlist/queue indicators, selectable items, informational items, etc.) and/or the like. According to some aspects of this disclosure, displaying, rendering, and/or presenting interactive elements may be facilitated via a just-in-time compiled programming language such as JavaScript, Typescript, Dart, ClojureScript, Ruby, Python, and/or the like. Additionally, technology including JavaScript with dynamic generation of a Document Object Model (DOM), Cascading Style Sheets (CSS), jQuery, Asynchronous JavaScript and XML (AJAX), and code libraries may be used to generate, render, and/or cause the display of one or more interactive elements within a user interface.

According to some aspects of this disclosure, computing device 110 (and user device 104) may use any user interface interaction method to cause a user interface to display a user interface for managing access to facility 120. The user interface may not only manage the flow of users/user device 104 accessing facility 120 based on capacity but may also prioritizes access based on digital instrument types which may be associated with various membership tiers.

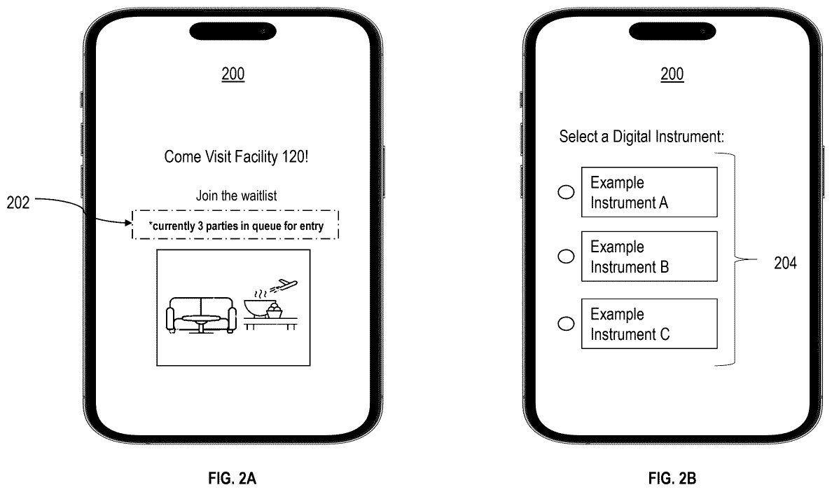

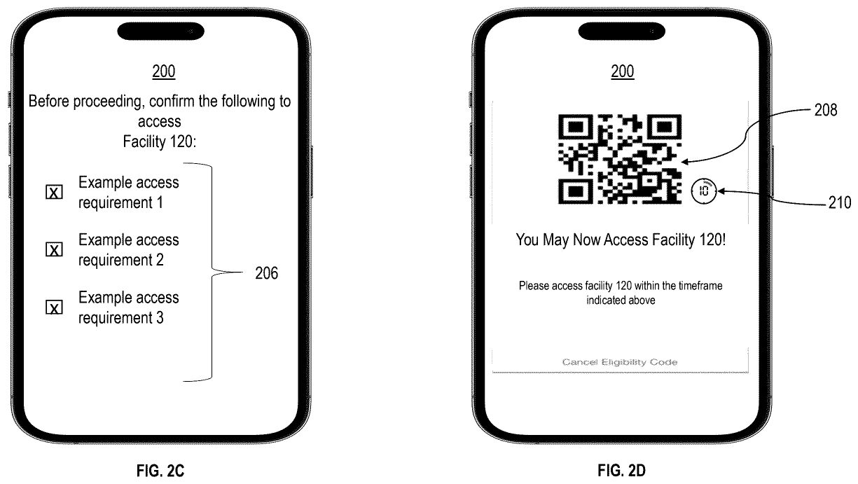

FIG. 2A shows an example user interface 200 for location queuing using digital instruments. In an example scenario, a user of user device 104 may scan a QR code and/or the like located at an entrance to facility 120. A scan of the QR code may cause user interface 200 to display indicator 202. Indicator 202 may indicate current queue information for facility 120. For example, as shown indicator 202 may indicate the amount of users waiting in queue to enter facility 120. In another example scenario, a user of user device 104 may receive a notification or instruction from computing device 110 that causes user device 104 to display user interface 200. For example, computing device 110 may send a notification or instruction to user device 104 that causes user device 104 to display user interface 200 based on user device 104 being in proximity to facility 120.

To access facility 120 according to the current queue information, user interface 200 may be used to provide credentials for user device 104 and or a user of user device 104. Submission of valid credentials may cause user device 104 to display user interface 200 as shown in FIG. 2B. As shown in FIG. 2B, user interface 200 may display an indication of a digital instrument (e.g., example instrument A, etc.). According to some aspects of this disclosure, when a user/user device 104 is associated with multiple digital instruments, user interface 200 may display a list 204 of digital instruments (e.g., example instrument A, example instrument A, example instrument B, example instrument C, etc.).

According to some aspects of this disclosure, information on list 204 may be displayed in any order. According to some aspects of this disclosure, list 204 may be ordered according to the frequency of use of the digital instruments. According to some aspects of this disclosure, list 204 may be ordered according to membership and/or group types associated with the digital instruments. According to some aspects of this disclosure, list 204 may be may be a ranked list of digital instruments. A rank for a digital instrument may be based on a digital instrument type, a membership/group/tiered program (e.g., prioritized status, platinum/gold status, basic/general status, etc.) associated with a digital instrument, a frequency of use, user preferences, and/or the like.

According to some aspects of this disclosure, computing device 110 may include one or more predictive models specifically trained to rank digital instruments based on various factors including, but not limited to, digital instrument type, companion/guess access availability, user preferences, reward/benefit program membership, time-of-day, historical facility access data, and/or the like. A predictive model may be specifically trained to rank digital instruments according to any factors. In other embodiments, a predictive model may be implemented at user device 104 or in a device implemented at facility 120.

According to some aspects of this disclosure, predictive models associated with computing device 110 may be trained based on labeled datasets (generated from feature engineering, etc.) relating to, but not limited to, ranking parameters, historical data describing digital instrument ranking, digital instrument usage patterns, reward/value program information, and/or the like. Predictive models associated with computing device 110 may include, but are not limited to, regression models, classification models, and/or the like. According to some aspects of this disclosure, predictive models associated with computing device 110 may utilize linear regression, decision trees, random forests, gradient boosting machines, neural networks, and/or the like suitable for ranking digital instruments to facilitate location queuing using digital instruments and/or the like.

When training predictive models associated with computing device 110, data used in developing datasets may be split into a training set and a validation set, where the training set is used to train the predictive model(s), and the validation set is used to tune the predictive model(s) parameters and avoid overfitting. The performance of predictive models associated with computing device 110 may be evaluated according to relevant metrics. For example, for regression tasks, a relevant metric may be mean absolute error (MAE) or root mean square error (RMSE). For classification tasks, a relevant metric may include, but is not limited to, accuracy, precision, recall, and/or the like. Once a predictive model associated with computing device 110 is trained and evaluated, it can be used to make predictions on new data. The predictive model may be periodically retrained on new data, to ensure the predictive model remains accurate as conditions change.

A digital instrument listed in list 204 may be selected via an interaction with user interface 200. According to some aspects of this disclosure, a selection of a digital instrument may cause user device 104 to display additional screens or options of user interface 200. For example, a selection of a digital instrument may cause user device 104 to display an interactive element for confirming and/or providing contact information (e.g., a phone number, texting information, email, etc.) associated with a user/user device 104 that may be used to receive notifications associated with facility 120. Notifications associated with facility 120 may include, but are not limited to, notifications that indicate a waitlist status for facility 120, notifications detailing when access to facility 120 is available, and/or the like. According to some aspects of this disclosure, a selection of a digital instrument may cause user device 104 to display an additional screen or option of user interface 200 such as a screen or option to add guests of user/user device 104 as intended visitors to facility 120.

As previously described, each digital instrument may be associated with one or more requirements for access facility 120. A selection of a digital instrument displayed by user interface 200 causes user interface 200 to display one or more access requirements associated with the digital instrument and/or the type of digital instrument. FIG. 2C shows an example of user interface 200 depicting a list 206 of access requirements for accessing facility 120 that are associated with a digital instrument selected in FIG. 2B.

Based on the confirmation of the access requirements for accessing facility 120 indicated by list 206, computing device may place user device 104 into a queue (on a waitlist) for accessing facility 120. According to some aspects of this disclosure, a queuing threshold and/or queue time for user device 104 to access facility 120 may be based on a type of digital instrument selected in FIG. 2B. For example, based on a first type of digital instrument selected (e.g., example instrument A, etc.), computing device 110 may send a notification to user device 104 instructing user device immediate access (e.g., no queue time/threshold, no need to wait on a waitlist, etc.) is available to facility 120. Based on a second type of digital instrument selected (e.g., example instrument B, etc.), computing device 110 may send a notification to user device 104 informing user device 104 that access to facility 120 may be available within a predefined timeframe (e.g., a reduced queue time/threshold, a need to wait on a waitlist, etc.). Notifications regarding access to facility 120 may be sent to user device 104 via contact information (e.g., a phone number, texting information, email, etc.) associated with a user/user device 104.

To enable access to facility 120, computing device 110 may generate an access identifier. The access identifier may be sent to user device 104 to be presented at an entrance of facility 120 and facilitate access to facility 120. According to some aspects of this disclosure, an access identifier for facility 120 may be encoded into image data (e.g., a barcode, a matrix barcode, a quick response (QR) code, Radio Frequency Identification (RFID) tag, a marker, etc.). User device 104 may display the image data based on confirmation of the requirement for accessing the facility. For example, user device 104 may receive a notification that space is available within facility 120 and that user device 104 (a user of user device 104, etc.) may access facility 120.

FIG. 2D shows an example of user interface 200 depicting image data 208 (e.g., a barcode, a matrix barcode, a quick response (QR) code, Radio Frequency Identification (RFID) tag, a marker, etc.) that has been encoded with an access identifier that facilitates access to facility 120. According to some aspects of this disclosure, image data 208 may be displayed along with a time element 210. Time element 210 may indicate an amount of time during which the access identifier for accessing facility 120 is valid and/or may facilitate access to facility 120. The image data may be decoded by a user or entry device (e.g., computing device 110, etc.) associated with facility 120, and the access identifier may be used to access the facility.

According to some aspects of this disclosure, user interface 200 may display a route (not shown) from a current location of user device 104 to facility 120. For example, a current location of user device 104 may be determined via the GPS functionality of communication module 106 and sent to computing device 110. Additionally and/or alternatively, Wi-Fi triangulation, Bluetooth beacons, and/or the like within an area surrounding facility 120 and user device 104 may be used to identify the location of user device 104.

Computing device 110 may receive an indication of the location of user device 104 and access a mapping system (e.g., an airport geographic information system (GIS)) to identify optimal routes within the area (e.g., an airport, etc.) surrounding facility 120 and user device 104. To identify optimal routes, a predictive model of computing device 110 may consider various factors such as distance, current crowd levels (e.g., based on information received from one or more sensors, imaging devices, etc.), and identify any obstructions (e.g. maintenance, detours, emergencies, etc.). The predictive model may use algorithms including, but not limited to, Dijkstra's, A* (A-star), and/or the like to identify the shortest path from the current location of user device 104 and facility 120.

Computing device 110 may send an indication of an identified optimal route to user device 104 to guide user device 104 toward facility 120. According to some aspects of this disclosure, a route may be displayed by user device 104 via an interactive map of user interface 200. The interactive map may include step-by-step directions, options to display an estimated time of arrival (ETA) at facility 120, notifications for any changes in the optimal route, and/or the like.

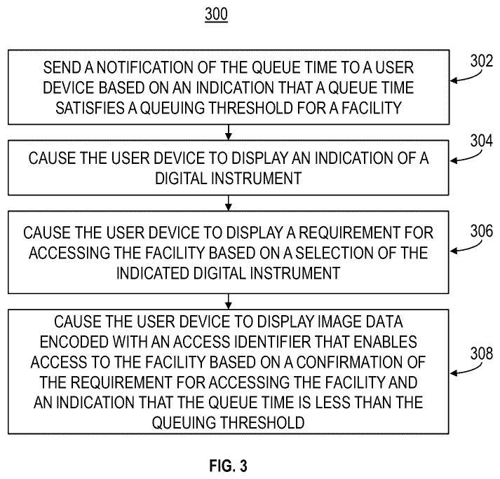

FIG. 3 shows a flowchart of an example method 300 for location queuing using digital instruments, according to some aspects of this disclosure. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIGS. 1-2C. However, method 300 is not limited to the aspects of those figures.

In 302, computing device 110 sends a notification of the queue time to a user device, such as user device 104. Computing device 110 may send the notification of the queue time to the user device based on an indication that a queue time satisfies a queuing threshold for a facility (e.g., a lounge, a venue, merchant location, any defined area, etc.).

According to some aspects of this disclosure, computing device 110 may generate an indication that the queue time satisfies the queuing threshold for the facility based on sensor data from a sensing device associated with the facility that indicates a service capacity for the facility. For example, one or more sensors associated with the facility may collect data at defined intervals to track the presence and flow of user/user device within the facility. Sensors may include, but or not limited to, These may include infrared sensors for detecting body heat, motion detectors for detecting user/user device motion within the facility, imaging devices that use image recognition to identify user/user devices entering and exiting the facility, and/or the like. Computing device 110 may process data from sensors associated with the facility to assess real-time occupancy levels and identify when these levels reach a set maximum capacity (e.g., queuing threshold, etc.) for the facility.

According to some aspects of this disclosure, to receive the notification of the queue time, the user device may access a uniform resource locator (URL) and/or scan a quick response (QR) code associated with the facility. Accessing the URL and/or scanning the QR code may cause the user device to display the notification of the queue time. According to some aspects of this disclosure, computing device 110 may send the notification of the queue time to the user device based on an indication that the user device is within proximity to the facility. According to some aspects of this disclosure, to receive the notification of the queue time, the user device may be configured with an application that receives occupancy data for the facility and notifies the user device of the queue time.

In 304, computing device 110 causes the user device to display an indication of a digital instrument. Computing device 110 may cause the user device to display the indication of the digital instrument based on credential information (e.g., a user/user device identifier, a password, a biometric, etc.) received from the user device. According to some aspects of this disclosure, computing device 110 causing the user device to display the indication of the digital instrument may include computing device 110 causing the user device to display a ranked list of digital instruments. The selected digital instrument may be a highest-ranked digital instrument indicated by the ranked list of digital instruments. The selected digital instrument may be any ranked digital instrument indicated by the ranked list of digital instruments. A rank for a digital instrument may be based on a digital instrument type, a frequency of use, user preferences, and/or the like.

In 306, computing device 110 causes the user device to display a requirement for accessing the facility. Computing device 110 may cause the user device to display the requirement for accessing the facility based on a selection of the indicated digital instrument. For example, computing device 110 may support different types and/or classifications of digital instruments, and each digital instrument may be associated with one or more requirements for accessing the facility. For example, when the facility is an airport lounge, requirements for access to the facility may include, but are not limited to, a boarding pass, an identification element, a membership, a qualifying airline ticket, a temporal requirement (e.g., accessing the facility within a certain timeframe, etc.), a location requirement, and/or the like.

According to some aspects of this disclosure, computing device 110 adjusts the queuing threshold based on the type of the digital instrument. For example, a first type of digital instrument may enable a user/user device associated with the digital instrument to access the facility without traversing a queue or waiting on a waitlist for the facility. A second type of digital instrument may require a user/user device associated with the digital instrument to access the facility once the queue time for the facility and/or amount of user/user devices on a waitlist for the facility is less than a specific value.

In 308, computing device 110 causes the user device to display image data (e.g., a barcode, a matrix barcode, a quick response (QR) code, Radio Frequency Identification (RFID) tag, a marker, etc.) encoded with an access identifier that enables access to the facility. Computing device 110 may cause the user device to display the image data based on confirmation of the requirement for accessing the facility and an indication that the queue time is less than the queuing threshold. According to some aspects of this disclosure, the matric barcode may be displayed by a user interface of the user device and may include a timer in proximity to the image data that indicates the amount of time that the access identifier is valid for accessing the facility. The image data may be decoded by a user or entry device associated with the facility and the access identifier may be used to access the facility.

According to some aspects of this disclosure, method 300 may include computing device 110 causing the user device to display a route from a location where the user device is located to the facility and/or an estimated time of arrival for the user/user device to travel to the facility based on an indication of the location received from (or detected for) the user device.

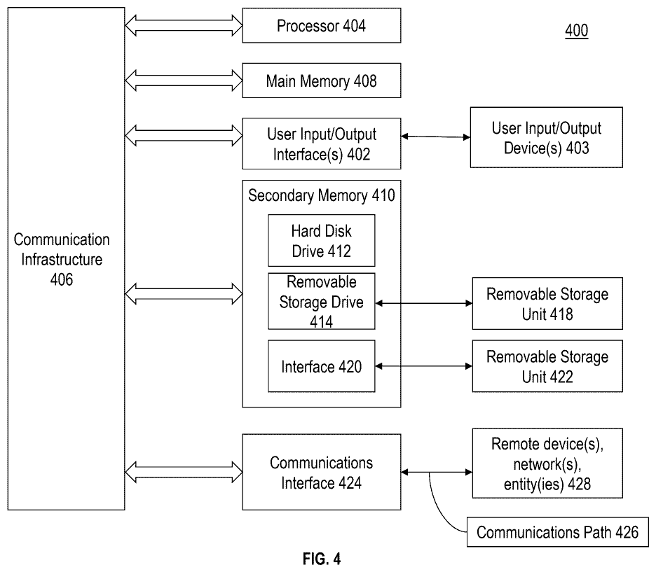

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
sending, based on a first indication that a queue time satisfies a queuing threshold for a facility, a notification of the queue time to a user device;
causing, based on credential information received from the user device, the user device to display an indication of a digital instrument;
causing, based on a selection of the indicated digital instrument, the user device to display a requirement for accessing the facility; and
causing, based on a confirmation of the requirement for accessing the facility and a second indication that the queue time is less than the queuing threshold, the user device to display image data encoded with an access identifier that enables access to the facility.

2. The computer-implemented method of claim 1, further comprising generating the first indication that the queue time satisfies the queuing threshold for the facility based on sensor data from a sensing device associated with the facility that indicates a service capacity for the facility.

3. The computer-implemented method of claim 1, wherein the sending the notification of the queue time to the user device is further based on an indication that the user device is within proximity to the facility.

4. The computer-implemented method of claim 1, further comprising causing, based on an indication of a location of the user device, the user device to display a route from the location to the facility.

5. The computer-implemented method of claim 1, wherein the causing the user device to display the indication of the digital instrument further comprises causing the user device to display a ranked list of digital instruments, wherein the digital instrument is a highest-ranked digital instrument indicated by the ranked list of digital instruments.

6. The computer-implemented method of claim 1, wherein, based on a type of the digital instrument, the access identifier enables additional user devices indicated by the user device to access the facility.

7. The computer-implemented method of claim 1, further comprising adjusting, based on a type of the digital instrument, the queuing threshold.

8. A system, comprising:
a memory; and
at least one processor coupled to the memory and configured to perform operations comprising:
sending, based on a first indication that a queue time satisfies a queuing threshold for a facility, a notification of the queue time to a user device;
causing, based on credential information received from the user device, the user device to display an indication of a digital instrument;
causing, based on a selection of the indicated digital instrument, the user device to display a requirement for accessing the facility; and
causing, based on a confirmation of the requirement for accessing the facility and a second indication that the queue time is less than the queuing threshold, the user device to display image data encoded with an access identifier that enables access to the facility.

9. The system of claim 8, the operations further comprising generating the first indication that the queue time satisfies the queuing threshold for the facility based on sensor data from a sensing device associated with the facility that indicates a service capacity for the facility.

10. The system of claim 8, wherein the sending the notification of the queue time to the user device is further based on an indication that the user device is within proximity to the facility.

11. The system of claim 8, the operations further comprising causing, based on an indication of a location of the user device, the user device to display a route from the location to the facility.

12. The system of claim 8, wherein the causing the user device to display the indication of the digital instrument further comprises causing the user device to display a ranked list of digital instruments, wherein the digital instrument is a highest-ranked digital instrument indicated by the ranked list of digital instruments.

13. The system of claim 8, wherein, based on a type of the digital instrument, the access identifier enables additional user devices indicated by the user device to access the facility.

14. The system of claim 8, the operations further comprising adjusting, based on a type of the digital instrument, the queuing threshold.

15. A non-transitory computer-readable medium having instructions stored thereon that, when executed by at least one computing device, causes the at least one computing device to perform operations comprising:
sending, based on a first indication that a queue time satisfies a queuing threshold for a facility, a notification of the queue time to a user device;
causing, based on credential information received from the user device, the user device to display an indication of a digital instrument;
causing, based on a selection of the indicated digital instrument, the user device to display a requirement for accessing the facility; and
causing, based on a confirmation of the requirement for accessing the facility and a second indication that the queue time is less than the queuing threshold, the user device to display image data encoded with an access identifier that enables access to the facility.

16. The system of claim 8, the operations further comprising generating the first indication that the queue time satisfies the queuing threshold for the facility based on sensor data from a sensing device associated with the facility that indicates a service capacity for the facility.

17. The system of claim 8, wherein the sending the notification of the queue time to the user device is further based on an indication that the user device is within proximity to the facility.

18. The system of claim 8, the operations further comprising causing, based on an indication of a location of the user device, the user device to display a route from the location to the facility.

19. The system of claim 8, wherein the causing the user device to display the indication of the digital instrument further comprises causing the user device to display a ranked list of digital instruments, wherein the digital instrument is a highest-ranked digital instrument indicated by the ranked list of digital instruments.

20. The system of claim 8, wherein, based on a type of the digital instrument, at least one of the access identifier enables additional user devices indicated by the user device to access the facility, or the queuing threshold is adjusted.
